(19) United States
(12) Patent Application Publication
(10) Pub. No.: US 2022/0028615 A1
(43) Pub. Date: Jan. 27, 2022

(54) Polarizable Sol-Gel Materials, Methods of Preparation and Processing for High Energy and Power Storage Devices

(71) Applicant: Georgia Tech Research Corporation, Atlanta, GA (US)

(72) Inventors: Joseph W. Perry, Atlanta, GA (US); Mohanalingam Kathaperumal, Atlanta, GA (US); Yun Sang Kim, Atlanta, GA (US)

(21) Appl. No.: 17/494,053

(22) Filed: Oct. 5, 2021

Related U.S. Application Data
(62) Division of application No. 16/301,029, filed on Nov. 13, 2018.
(60) Provisional application No. 62/335,108, filed on May 12, 2016.

(51) Int. Cl. H01G 4/18; C08G 77/26; H01G 4/33; C09D 183/08; C23C 18/12; H01G 4/14; H01G 4/20

(52) U.S. Cl. CPC H01G 4/18; C08G 77/26; H01G 4/33; C09D 183/08; C23C 18/1254; H01G 4/1227; H01G 4/14; C23C 18/1245; C23C 18/122; H01G 4/206; C23C 18/1241

(57) ABSTRACT

Methods of processing a capacitor device with high energy density and high extraction efficiency based on sol-gel films. The films can be formed by use of a single precursor, including siloxane precursors bearing a polar group on a flexible tethering group. The sol-gel compositions used in the formation of films can have high dielectric permittivity, low dielectric loss, high breakdown strength and high-energy storage properties. The methods can be well suited for both high energy density and high power density to provide enhanced energy storage capabilities for discrete, embedded or on-chip integrated capacitor applications, gate dielectrics for transistors and displays, capacitive touch screens, light weight mobile defibrillators, filters for cellular devices, electric propulsion, electric vehicles, power invertors for microgrid storage, load leveling of transients on a wide range of timescales for medium voltage electric grids.

### CROSS-REFERENCE TO RELATED APPLICATIONS

This application is a divisional of U.S. application Ser. No. 16/301,029 filed 13 Nov. 2018, which is a National Stage Entry of PCT/US17/32414 filed 12 May 2017, which claims benefit of priority under 35 USC § 119(e) of U.S. Provisional Patent Application No. 62/335,108, filed 12 May 2016, each of which is incorporated by reference herein in its entirety as if fully set forth below.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates generally to electrical energy storage devices, and more particularly to polarizable sol-gel materials, methods of preparation and processing for high energy and power storage devices. The present invention relates to high energy and/or power density materials and devices with high energy extraction efficiency derived from organic-inorganic sol-gel film based devices.

### 2. Description of Related Art

Electrical energy storage devices can be increasingly important as a class of devices for both high-energy density and high-power density to provide enhanced energy storage capabilities for a very wide variety of applications, including but not limited to discrete, embedded or on-chip integrated capacitor applications, gate dielectrics for transistors and displays, capacitive touch screens, filters for cellular devices, defibrillators, electric propulsion, electric vehicles, power invertors, microgrid storage, and load leveling of transients over a wide range of timescales for medium voltage electric grids. Among high-performance energy storage materials and devices, such as capacitors, supercapacitors, batteries, and fuel cells, capacitors can be advantageous for high power density because of their fast electrical charge and discharge responses. The performance of capacitors can be limited by the characteristics of the dielectric storage material. Such limitations can include permittivity, electrical loss, breakdown strength and statistics, and processability. The stored energy density (U) in dielectric films can be generally expressed as shown in Equation (1):

U=∫EdD (1)

where E is the applied electric field and D is the electric displacement.

In addition to having a high dielectric strength, a large electric displacement that can be obtained through high permittivity can also be desirable to maximize the storage capacity of dielectric materials. A need exists for, among other things, the development of materials that possess high permittivity, large breakdown strength, low loss at high electric field, high reliability, and large energy extraction efficiency.

It is with respect to these and other considerations that the various embodiments described below are presented.

### BRIEF SUMMARY OF THE INVENTION

In some aspects, high energy and/or power density materials and devices with high energy extraction efficiency derived from organic-inorganic sol-gel film based devices are disclosed and the methods by which they are prepared. The solution of this disclosure further relates to devices derived from sols freshly prepared from the sol-gel precursors and also by the dissolution of the gel/powder formed from the precursors. The sol-gel film based devices herein are useful in various energy storage applications and possess both high energy and power densities.

In one embodiment, the sol-gel composition that forms the film layer of this disclosure can comprise of a sol-gel material formed from a single precursor. The sol-gel composition can be used in a capacitor for energy storing. The single precursor can contain a hydrolysable and condensable trialkoxysilane group which in the presence of a liquid catalyst undergoes cross-linking to produce a silicate network. In this regard, R may be an alkyl group such as methyl, ethyl, propyl or butyl while Z can be a polar group such as CN, —SCN, —NCO, —NH₂, —CF₃. Finally, n can be selected to be an integer in the range of 0 to about 10.

In another embodiment, a device for capacitor and energy storage is disclosed. The device includes a composition of a single sol-gel precursor according to formula (I):

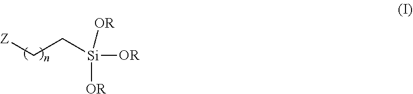

The composition has an overall weight. In the formula, R is an alkyl group that includes methyl, ethyl, propyl or butyl. Z is a polar group that includes CN, —SCN, —NCO, —NH₂, —CF₃. N is an integer ranging approximately between 0 and 10. In the device, a solvent is provided that accounts for at least 10% of the overall weight. A catalyst is also provided that accounts for at least 10% of the overall weight.

In other embodiments, the solvent can be methanol, ethanol, isopropyl alcohol, N, N-dimethylformamide, acetonitrile, N, N-dimethylacetamide, or tetrahydrofuran. In other embodiments, the catalyst comprises of 0.1 N hydrochloric acid and water. The catalyst can include 100% 0.1 N hydrochloric acid, ultrapure water, 1 to 99% of 0.1 N hydrochloric acid, or 1 to 99% of ultrapure water. The catalyst can include 100% of basic catalysts not limited to sodium hydroxide, ammonium hydroxide and barium hydroxide.

In other embodiments, the gel further can include of Z groups having a dipole moment of at least 0.25 D. The gel can have a shelf-life of at least a month. In other embodiments, the shelf life of the gel can be at least three months.

In other embodiments, a capacitor energy and power storage device comprising an inorganic-organic network formed using the sol-gel composition of this disclosure that includes a recurring unit of the following formula (II):

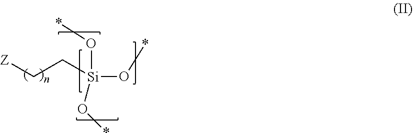

In other embodiments, the sol-gel composition is cast into a film and deposited on a substrate which is comprised of a metal or a semiconducting material. The film can include a thickness ranging between 30-4000 nm. A charge-blocking layer can also be deposited on top of the sol-gel film. In other embodiments, the composition can include a charge-blocking layer that includes of a polymer layer with thickness ranging from 5 to 500 nm. In other embodiments, the composition can include a charge-blocking layer that includes of a nanoscale metal oxide layer. The metal of the substrate can be Si, Al, Zn, Zr, and Hf. A thickness of the charge-blocking layer can range between 1 to 200 nm. In other embodiments, the composition can include a charge-blocking layer that comprises of an organic self-assembled monolayers selected from alkyl or aryl thiols, alkyl or aromatic phosphonic acids or alkyl or aryl silanes and alkyl or aryl siloxanes and alkyl or aryl carboxylic acids.

In other embodiments, the sol-gel film is deposited on a substrate comprising of a charge-blocking layer on a metal or a semiconducting layer. The charge-blocking layer can include of a polymer layer. The charge-blocking layer can include of a nanoscale metal oxide layer where the metal can be Si, Al, Zn, Zr, Hf and the layer thickness can be in the range of 1 to 200 nm. The charge-blocking layer can include of an organic self-assembled monolayers selected from alkyl or aryl thiols, alkyl or aromatic phosphonic acids or alkyl or aryl silanes and alkyl or aryl siloxanes and alkyl or aryl carboxylic acids.

In other embodiments, the sol-gel film can be sandwiched between two identical polymer layers. The sol-gel film can also be sandwiched between two identical oxide layers. The sol-gel film can be sandwiched between two organic self-assembled monolayers selected from alkyl or aryl thiols, alkyl or aromatic phosphonic acids or alkyl or aryl silanes and alkyl or aryl siloxanes and alkyl or aryl carboxylic acids. In other embodiments, thin layers of charge blocking layers are formed by dip coating, spin-casting, blade casting and spray casting.

In other embodiments, a sol-gel thin film device is provided that consists of a sol-gel film between a bottom and a top electrode. The sol-gel film is made of metal or conduction to semi-conducting metal oxides. A top electrode is made of metal or conduction to semi-conducting metal oxides. A first charge blocking layer is disposed between the bottom electrode and the sol-gel film. A second charge blocking layer is between the top electrode and the sol-gel film.

In other embodiments, a sol-gel thin film device is provided that consists of a sol-gel film between a bottom and a top electrode. The sol-gel film is transparent to opaque semi-conducting metal oxides. A top electrode is made of metal or conduction to semi-conducting metal oxides. A first charge blocking layer is between the bottom electrode and the sol-gel film. A second charge blocking layer is between the top electrode and the sol-gel film.

In other embodiments, a sol-gel thin film device is provided that consists of a sol-gel film between a bottom electrode made of metal or conduction to semi-conducting metal oxides. A top electrode is also provided that is made of metal or conduction to semi-conducting metal oxides. A first charge blocking layer is between the bottom electrode and the sol-gel film. A second charge blocking layer is between the top electrode and the sol-gel film.

In other embodiments, a sol-gel thin film device is provided that consists of a sol-gel film between a bottom electrode and transparent to opaque semi-conducting metal oxides. A top electrode is made of metal or conduction to semi-conducting metal oxides. A first charge blocking layer is between the bottom electrode and the sol-gel film. A second charge blocking layer is between top electrode and the sol-gel film.

In other embodiments, a flexible sol-gel thin film device is disclosed having one or more charge blocking layers. The device also includes a composition of a single sol-gel precursor. The precursor can include a hydrolysable and condensable trialkoxysilane group that undergoes cross-linking in the presence of a catalyst to produce a silicate network. The device also includes sol-gel dielectric films formed from the composition. The films are combined with the one or more charge blocking layers. In other embodiments, the sol-gel dielectric films are formed on a substrate. The substrate can include a glass or different metal layers of varying thickness. The device can also include an ultrathin layer of a polymer having a permittivity greater than 2, the ultrathin layer being disposed between the substrate and the sol-gel dielectric films. The substrate can also include a flexible substrate.

In other embodiments, the device can include an electrode positioned on the one or more charge blocking layers. The one or more charge blocking layers can be disposed on top of and/or below the sol-gel dielectric films. A glass layer can be disposed in communication with the one or more charge blocking layers and the film.

In other embodiments, the device can include a top electrode. At least one of the one or more charge blocking layers can be disposed between the sol-gel dielectric films and the top electrode. In other embodiments, the device can include a bottom electrode, wherein at least one of the one or more charge blocking layers can be between the bottom electrode and the sol-gel dielectric films. In other embodiments, the device can include a bottom electrode and a top electrode, wherein the one or more charge blocking layer can be between the bottom electrode, the top electrode, and the sol-gel dielectric films.

In other embodiments, the single sol-gel precursor of the device can include a trialkoxysilane having a cyanoalkyl polar group and water is the catalyst for hydrolysis. The cross-linked network of this embodiment exhibits higher extractable energy density and energy extraction efficiency.

In other embodiments, the single sol-gel precursor of the device can include a trialkoxysilane having a cyanoalkyl polar group and a mixture of water and hydrochloric acid is the catalyst. The cross-linked network of this embodiment exhibits higher extractable energy density and energy extraction efficiency.

In other embodiments, a method of processing a capacitor and energy storage device is disclosed. The method can include mixing a sol-gel material with liquid catalyst, the sol-gel material being formed from a composition formed from a single precursor; heating or drying the sol-gel material to remove a solvent thereby forming a dry powder; dissolving the powder with a solvent to form a solution; and casting the sol-gel material into a film. The sol-gel material processed in this method can have a shelf-life of at least one month.

In other embodiments, the method can also include sandwiching the film between two identical polymer layers; sandwiching the film between two identical oxide layers; and/or sandwiching the film between two organic self-assembled monolayers selected from alkyl or aryl thiols, alkyl or aromatic phosphonic acids or alkyl or aryl silanes and alkyl or aryl siloxanes.

In other embodiments, the method can also include positioning an electrode and a charge blocking layer on top of and/or below the film; providing a glass layer in communication with the one or more charge blocking layers and the film; and depositing the bottom conducting layer on top of the glass layer.

In other embodiments, the method can also include selecting the liquid catalyst from a plurality of liquid catalysts to hydrolyze and condense the single precursor; and maintaining relatively high permittivity in the sol-gel film by reducing leakage current of the film.

In other embodiments, the method can also include casting the sol-gel material into the film by spin, blade, or spray coating; scratching the film thereby obtaining the powder; re-dissolving the sol-gel material in the same or a different solvent; and/or applying the sol-gel material on one or more polymer layers for one or more predetermined electrical applications.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 depicts an example embodiment of a capacitor device of this disclosure.

FIG. 2 depicts an example wafer for use in a capacitor device of this disclosure.

FIG. 3 depicts an example wafer for use in a capacitor device of this disclosure.

FIG. 4 depicts an example wafer for use in a capacitor device of this disclosure.

FIG. 5 depicts an example wafer for use in a capacitor device of this disclosure.

FIG. 6 depicts leakage current measurements on cyanoethyltrimethoxysilane (CNETMS) films processed at different pH.

FIG. 7 depicts breakdown measurements on CNETMS films processed at different pH.

FIG. 8 depicts Weibull modulus measurements on CNETMS films processed at different pH.

FIG. 9 depicts discharged energy density of CNETMS films processed at different pH.

FIG. 10 depicts an example method of manufacturing a capacitor having a sol-gel material of this disclosure.

FIG. 11 depicts extractable energy density and energy extraction efficiency of CNETMS films processed at different pH.

FIG. 12 depicts chemical structures of sol-gel precursors described in this disclosure.

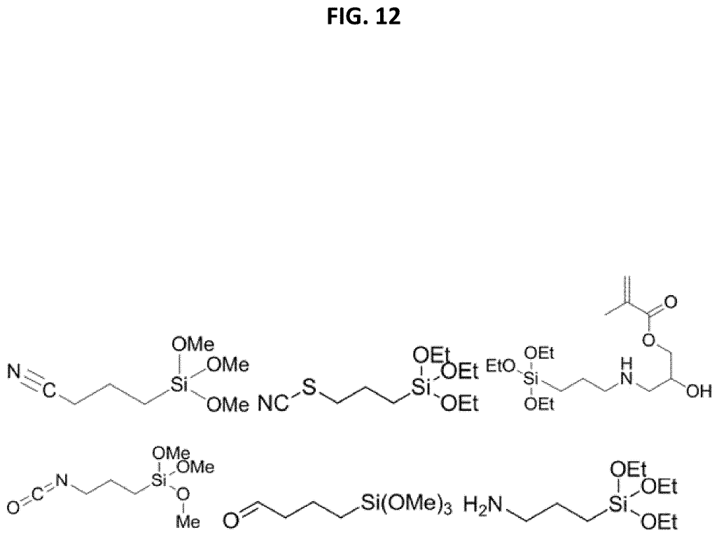

FIG. 13 depicts example chemical structures of polymers used as charge-blocking layers.

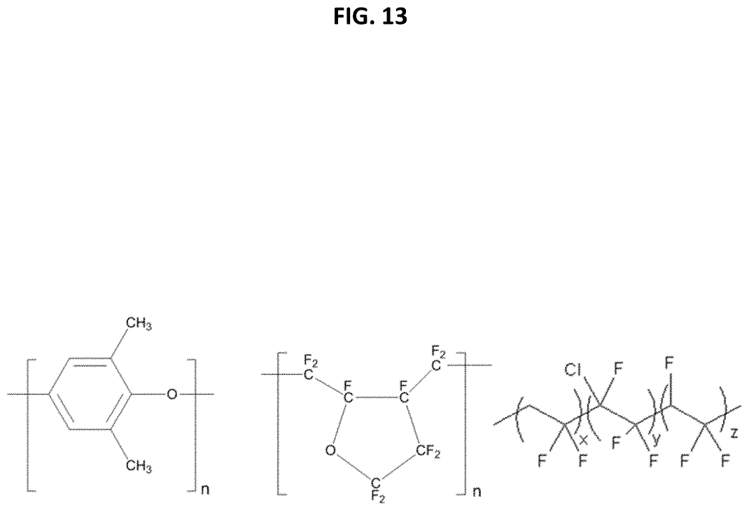

FIG. 14 depicts example chemical structures used as charge-blocking self-assembled monolayers.

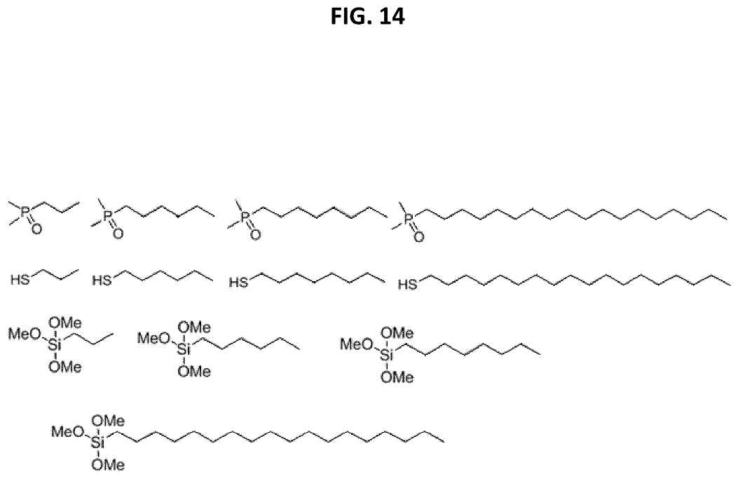

FIG. 15 depicts extractable energy density and energy extraction efficiency of CNETMS films with self-assembled monolayer of n-octylphosphonic acid as a charge-blocking layer.

FIG. 16 depicts extractable energy density and energy extraction efficiency of 300 nm CNETMS films with and without an octylphosphonic acid charge blocking layer.

FIG. 17 depicts extractable energy density and energy extraction efficiency of 200 nm CNETMS films without a charge-blocking layer.

FIG. 18 depicts extractable energy density and energy extraction efficiency of 85 nm CNETMS films with and without an octylphosphonic acid charge blocking layer.

### DETAILED DESCRIPTION OF THE INVENTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Using “comprising” or “including” or like terms means that at least the named compound, element, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The solution of this disclosure generally relates to capacitor, energy storing devices derived from sol-gels freshly prepared from one or more sol-gel precursors and also by the dissolution of the gel formed from the precursors. The sol-gel film based devices of this disclosure are useful in various energy storage applications and possess both high energy and power densities.

There is a critical need for materials and material compositions for energy and power storage that have high dielectric constant, low dielectric loss, and breakdown strength, as well as high extractable energy/power density and energy/power extraction efficiency. Because of the need to satisfy multiple device properties including reliability of device breakdown, it is often difficult to find a suitable material for efficient, high energy density storage. The present disclosure provides compositions and processing methods for sol-gel materials suited for energy storage applications. Specifically, this disclosure can be tuned and/or tailored to improve the properties the sol-gel material such as, for example, dielectric permittivity, breakdown strength, and energy density and energy extraction efficiency of the devices. Embodiments of the sol-gel based materials of this disclosure demonstrate the role of the processing methods to improve energy storage characteristics of sol-gel materials.

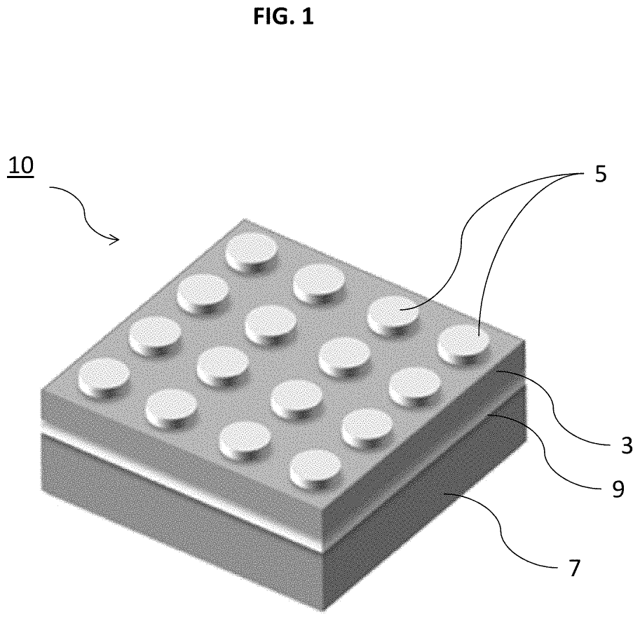

The gel/powders in this disclosure obtained from the compositions can be redissolved in certain solvents that allow obtaining thin films, increasing the shelf-life of the otherwise short-lived sol-gel sols. Furthermore, use of specific nanoscale and monolayer blocking layers, including various metal oxides, alkyl phosphonic acids, alkylthiols, and polymeric layers, in combination with sol-gel dielectric films lead to enhanced energy storage properties. Turning to FIG. 1, an example embodiment of a capacitor device 10 of this disclosure is shown. Specifically, FIG. 1 shows a schematic representation of an example thin-film capacitor device 10 of this disclosure that employs a bi-layer dielectric that can be formed by a monolayer 3, a sol-gel film 9, and one or more electrode layers 5. As shown, the electrode layers 5 can be formed from a metal, such as Aluminum. Layer 7 can be formed from a glass or ITO (indium tin oxide). It is also understood that device 10 depicted in FIG. 1 is not necessarily drawn to scale and is strictly for schematic purposes. The bilayer structure of device 10 can block the injection of electrons into the sol-gel film 9, providing low leakage current, high breakdown strength, and high energy extraction efficiency.

In one embodiment, the sol-gel composition that forms the film layer of this disclosure can comprise of a sol-gel material formed from a single precursor. The sol-gel composition can be used in a capacitor for energy storing. The single precursor can contain a hydrolysable and condensable trialkoxysilane group which in the presence of a liquid catalyst undergoes cross-linking to produce a silicate network. In this regard, R may be an alkyl group such as methyl, ethyl, propyl or butyl while Z can be a polar group such as CN, —SCN, —NCO, —NH₂, —CF₃. Finally, n can be selected to be an integer in the range of 0 to about 10.

In a certain embodiments, a trialkoxysilane having a cyanoalkyl polar group is used as a precursor and water is used as the catalyst for hydrolysis. In this respect, the cross-linked network exhibits higher extractable energy density and energy extraction efficiency. In other embodiments, the catalyst used can include a mixture of water and hydrochloric acid. In another embodiment, the sol-gel composition can be used for energy storage with a high dielectric strength and high dielectric constant thin film device. This provides a high permittivity dielectric solid which can be also re-dissolved in different solvents to apply on other polymer layers for different electrical applications. Moreover, the gel produced in certain embodiments using water as a catalyst can be heated to remove the solvent thereby obtaining a dry powder. A solution can be prepared from the dry powder which can be coated as a film of desired thickness. Processes that can be used include spin, blade or spray coating. In another embodiment, the thickness of the ranges between 30 nm to 10,000 nm.

In certain embodiments, a method for further improving the energy storage capability of the sol-gel composition is disclosed. The method utilizes a charge blocking nano- or mono-layer of polymer, organic and inorganic metal oxide. The method can also utilize ultrahigh breakdown strength material as a charge blocking layer. The ultrahigh breakdown material can include a diamond or hexagonal boron nitride deposited by chemical vapor deposition or other deposition methods. In another embodiment, the ultrahigh breakdown material can include a wide band gap (e.g., hexagonal boron nitride (ca. 6 eV)).

In other embodiments, a method for improving the energy/power storage capability of the sol-gel composition is disclosed. In this method, the sol-gel can be used as a host material for inorganic fillers that include barium titanate, strontium titanate, barium strontium titanate and/or related high dielectric materials. In another embodiment, the inorganic fillers are different sized nanoparticles. In another embodiment, the inorganic fillers can be functionalized on their surface with suitable groups that will help disperse them in the sol-gel host.

In some embodiments, a charge blocking nano/mono-layer can be disposed between the sol-gel dielectric layer and the top metal electrode. In another embodiment, the charge blocking layer is between the bottom electrode and the sol-gel dielectric layer. The charge blocking layer can be present between both the bottom electrode and sol-gel layer as well as between the sol-gel layer and the top electrode.

A sol-gel precursor of the composition of this disclosure can include a monomer according to the structural formula (I), as described earlier. The R group can be an alkyl linker of varying lengths, such as a methyl, ethyl, propyl, butyl, pentyl, hexyl, heptyl, octyl, nonyl, decyl and/or undecyl group. In one embodiment, the Z group can be substituted with a halogen atom, or cyano group. Non-limiting examples of substituent groups can include F, Cl, Br, I, CN or any group in Scheme 1, wherein n can be selected to be an integer in the range of 0 to 10.

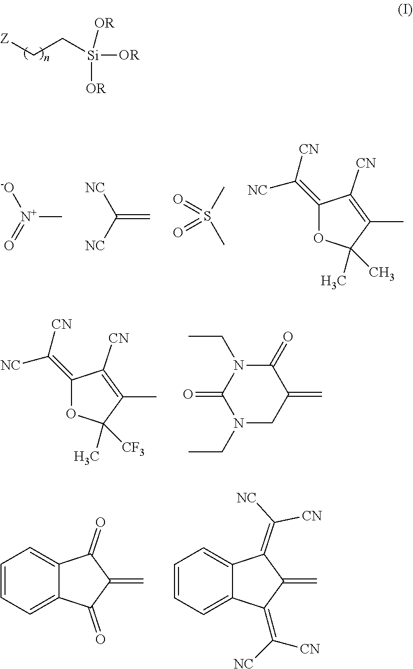

Scheme 1. Polar (Z) groups in formula (I).

In another embodiment, a sol-gel precursor is provided that includes a monomer according to the structural formula (III). The R group in this respect is an alkyl group that can include a methyl, ethyl, propyl, butyl, pentyl, hexyl, heptyl, octyl, nonyl, decyl and/or undecyl group. Similar to other embodiments, n can be an integer in the range of 0 to 10. R₂ can be a hydrogen atom or an alkyl group which could be a methyl, ethyl, propyl, butyl, pentyl, hexyl, heptyl, octyl, nonyl, decyl and/or undecyl group.

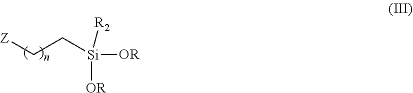

In another embodiment, two hydrogen atoms attached to an alkyl group can be replaced with Z group which could be a F, Cl, Br, I and —CN group. This is advantageous as it increases the polar nature of the moiety as in the formula given in formulas IV, V and VI.

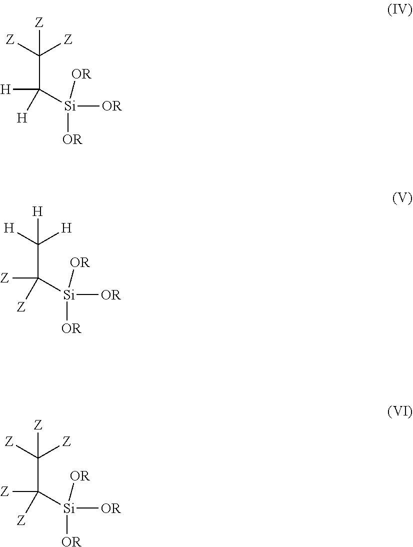

In another embodiment, a substituted ethyl group of the sol-gel precursor can include a Z group of F, Cl, Br, I or —CN. In those embodiments according to the structural formula (IV), the number of electronegative groups can vary from 1 to 3. In another embodiment according to structural formula (V), the number of electronegative groups can be one or two. In another embodiment according to structural formula (VI), the number of electronegative groups can vary from 1 to 5. In another embodiment, polymerizable (e.g., acrylate, epoxy, vinyl or the like) moieties are attached to the alkyl groups which are a part of the trialkoxysilane.

In another embodiment, the hydrolysis followed by condensation of structural formulas (VII) or (VIII) will provide a relatively high dielectric film which can further be cross-linked by illuminating with UV light. In this regards, structures similar to structural formulas (VII) and (VIII) can produce films that can be patterned to any required shape or form on different substrates that can include ITO, Al, Ti, Ti—Au, Au, and flexible substrates such as Al-Mylar, ITO-PEN, ITO-polyester.

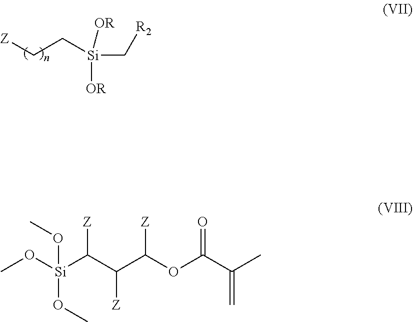

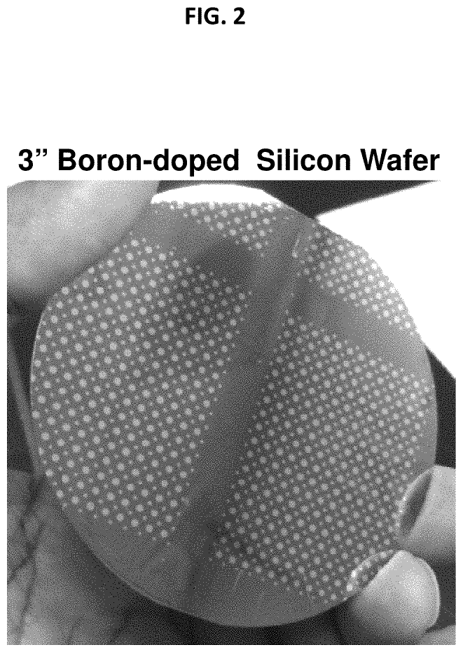

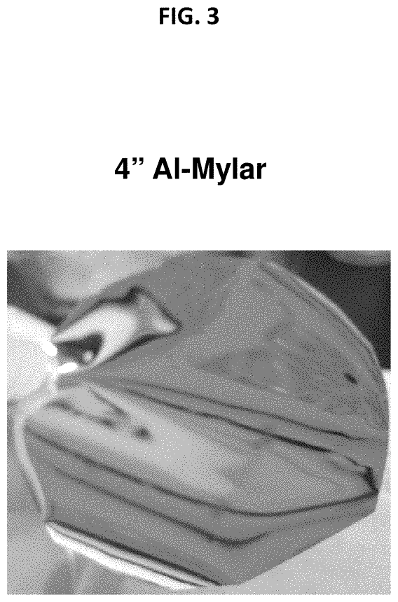

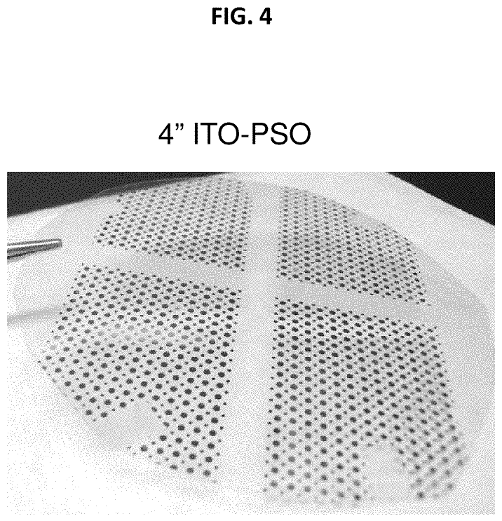

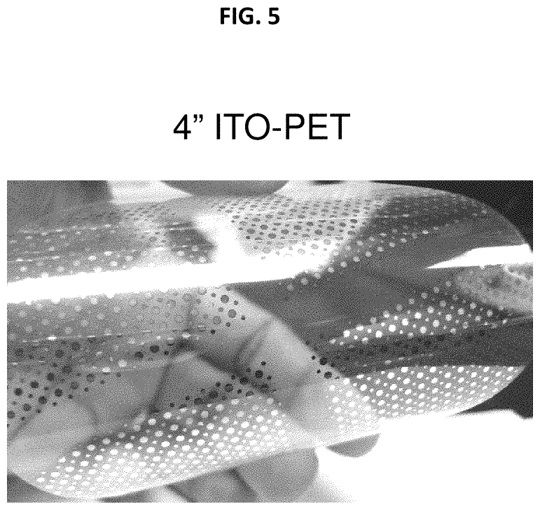

In another embodiment, the sol-gel precursor after hydrolysis is cast into films and dried at 130° C. for 3 hours. The dried film can be scratched to obtain cross-linked powders (e.g., those of structures IX and X). The cross-linked powders of the sol-gel precursor can be re-dissolved in a variety of solvents. In an embodiment, the powder dissolved in a solvent is spin- or blade-cast into films of high dielectric constant and low dielectric loss on substrates such as ITO, Al, Ti, Ti—Au, Au deposited glass or silicon wafer. However, flexible substrates can also be used, such Al-Mylar, ITO-PEN, ITO-polyester as shown in FIGS. 2-5:

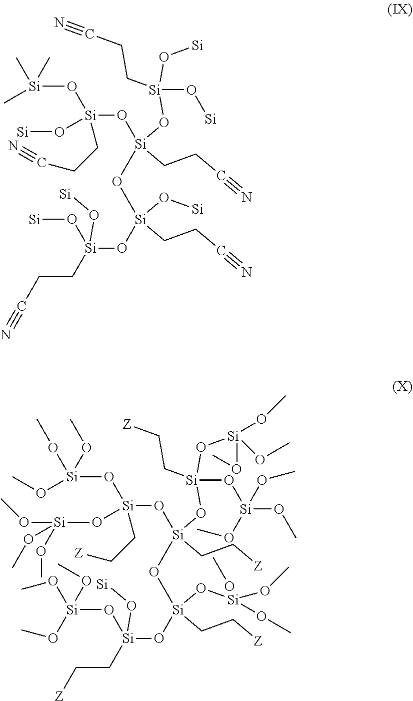

### EXAMPLES

Various aspects of the disclosed devices and methods may be still more fully understood from the following description of some example implementations and corresponding results. Some experimental data is presented herein for purposes of illustration and should not be construed as limiting the scope of the disclosed technology in any way or excluding any alternative or additional embodiments.

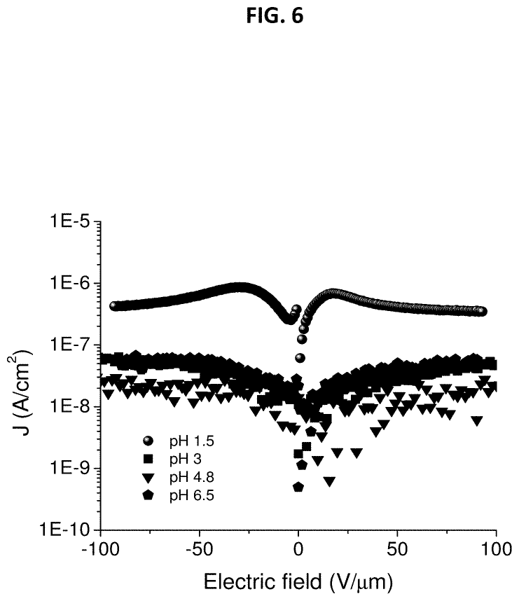

FIG. 6 shows a plot of the leakage current measured as a function of voltage (I-V measurements). The measured current density is relatively high when the pH of the catalyst is 1.5. When the pH of the catalyst used was changed from 1.5 to 3, the current decreases by nearly an order of magnitude and any further increase in pH to 4.8 and 6.5 does not change the current significantly. This capability of selecting a particular catalyst to hydrolyze and condense sol-gel precursor to facilitate a reduction in leakage current while maintaining high permittivity of films, makes a broad range of device applications feasible. The possible sources of current in these films are the ions (H+, OH−, MeO− and Cl−) generated from the catalyst used for the sol-gel hydrolysis and condensation. For example, 0.1 N HCl (at pH 1.5), a mixture of 0.1 N HCl and water (at pH 3 and pH 4.8) and only water (at pH 6.5). Based on the current values obtained from FIG. 6, it is possible that the main contribution to the current is from Cl− ions (Cl− ion concentration change as follows; pH 1.5>pH 3>pH 4.5>pH 6.5 and considering the other factors constant at different pH). Additional evidence of this trend has also been obtained from energy dispersive spectroscopy-SEM data and chlorine elemental map on the films processed at different pH. It is evident from the FIG. 6 that the newly developed processing methods lead to highly improved dielectric properties and a variety of device applications of the CNETMS sol-gel films.

The dielectric breakdown strengths of the CNETMS films were determined and analyzed using the Weibull method, as has been discussed elsewhere. The Weibull cumulative failure probability distribution (PF) is expressed by the following formula:

$${P}_{F} ( E ) = 1 - exp [ - {\{ \frac{( E - γ )}{α} \}}^{β} ] \qquad ( 2 )$$

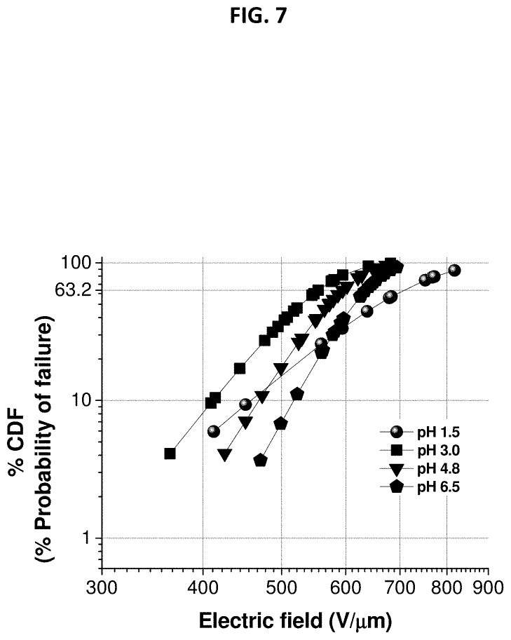

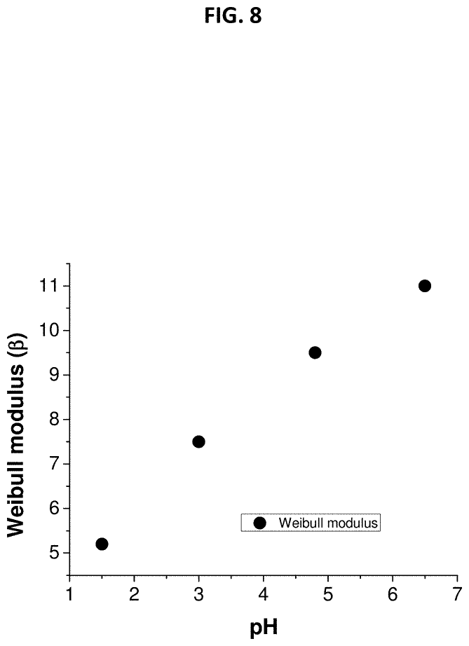

In the Weibull formula, E is the applied electric field, a is the “scale” parameter, 13 is the “shape” parameter or Weibull modulus that represents dispersion of the breakdown field, and y is the electric field breakdown threshold parameter that represents the field below which no observable failure occurs. Conventionally, the characteristic breakdown strength, E_{BD}, is defined as the field where P_{F} is 63.2%. The failure probability of the CNETMS films and the reliability parameter of devices fabricated from different pH as a function of the applied electric field are shown in FIG. 7 and FIG. 8 respectively. In general, the narrower the cumulative distribution function (CDF) with respect to electric field, the more reliable the material is for high dielectric strength applications. Breakdown measurements and Weibull analysis have been carried out on the films prepared from different pH are shown in FIG. 7. As evident from FIGS. 7 and 8, the increase in pH leads to a decrease in the breakdown voltage spread or narrower distribution of α and also an increase in the reliability parameter. β, the Weibull modulus, increases from about 5 to 11 when the pH was increased from 1.5 to 11. This increase in β, can be attributed to the decrease in chloride ion from pH 1.5 to pH 4.8 and then further to the complete absence of chloride ions at pH 6.5. The presences of ions/ionic species in films generally contribute to increase the conductivity/current.

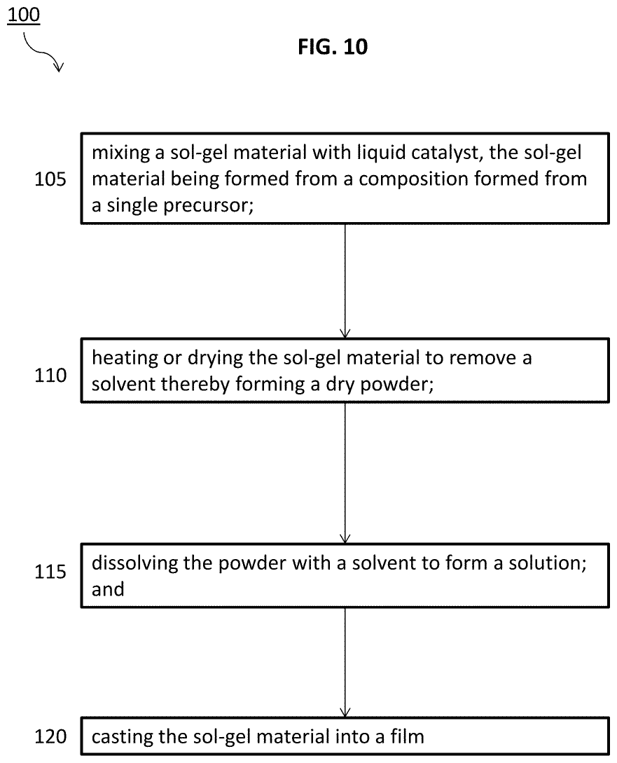

In other embodiments, as shown in FIG. 10, a method 100 is disclosed of processing a capacitor and energy storage device of this disclosure. The method 100 can include a first step, 105, mixing a sol-gel material with liquid catalyst, the sol-gel material being formed from a composition formed from a single precursor. A second step 110 includes heating or drying the sol-gel material to remove a solvent thereby forming a dry powder. A third step includes 115 dissolving the powder with a solvent to form a solution. A fourth step 120 includes casting the sol-gel material into a film. The sol-gel material processed in this method can have a shelf-life of at least one month.

Other steps are also contemplated in this method. For example, the method can also include sandwiching the film between two identical polymer layers; sandwiching the film between two identical oxide layers; and/or sandwiching the film between two organic self-assembled monolayers selected from alkyl or aryl thiols, alkyl or aromatic phosphonic acids or alkyl or aryl silanes and alkyl or aryl siloxanes. In other embodiments, the method can also include positioning an electrode and a charge blocking layer on top of and/or below the film; providing a glass layer in communication with the one or more charge blocking layers and the film; and depositing the bottom conducting layer on top of the glass layer. In other embodiments, the method can also include selecting the liquid catalyst from a plurality of liquid catalysts to hydrolyze and condense the single precursor; and maintaining relatively high permittivity in the sol-gel film by reducing leakage current of the film. In other embodiments, the method can also include casting the sol-gel material into the film by spin, blade, or spray coating; scratching the film thereby obtaining the powder; re-dissolving the sol-gel material in the same or a different solvent; and/or applying the sol-gel material on one or more polymer layers for one or more predetermined electrical applications.

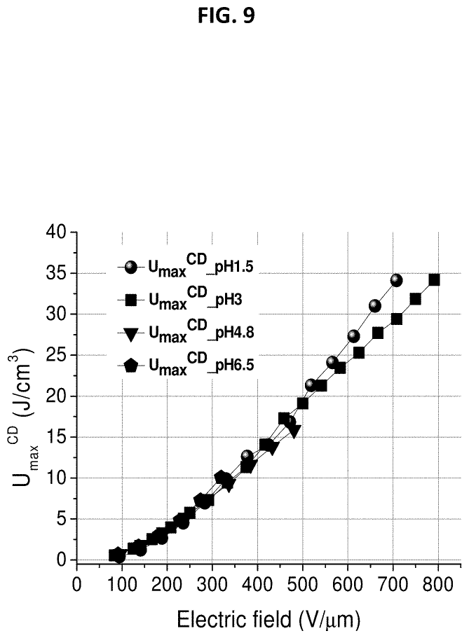

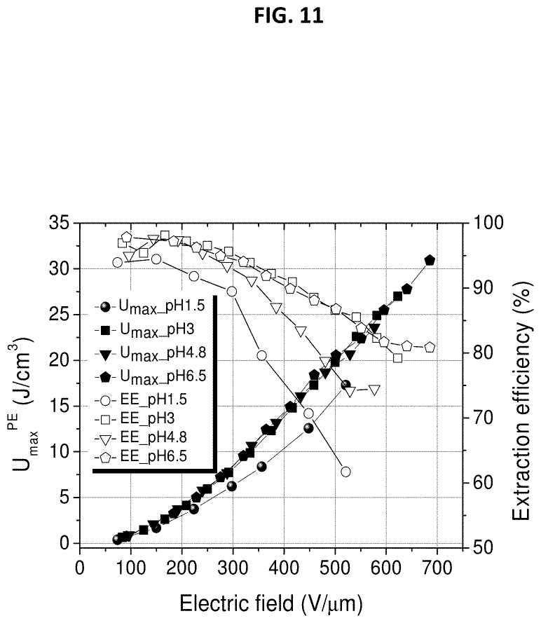

Turning to the examples, the field dependent Uₘₐₓ of CNETMS films processed at different pH from CD and PE measurements is shown in FIG. 9 and FIG. 11, respectively. Energy density measurements from charge-discharge methods show a large value of about 34 J/cm³. The improved processing method wherein the films were prepared by redissolving the gel in DMF exhibit energy density values of about 25 to 30 J/cm³ with an extraction efficiency of about 80%. This enhanced energy extraction efficiency has been achieved by improved processing methods via the use of ultrapure water for hydrolysis and thereby eliminating the presence of chloride ions during the sol and film formation.

In another embodiment, the sol-gel film can be with and without a charge blocking layer of any polymer or a monolayer of small to long-alkyl chain containing molecules may be formed by dissolving a powder of a dimer, trimer, tetramer, oligomer or polymer derived from sol-gel precursors. The dissolved sol-gel polymer may have a thickness of 25 to 100,000 nm as formed as well as be in the dried form.

In another embodiment, the sol-gel dielectric films, with and without the charge blocking layer can be formed on various types of substrates, as shown in FIGS. 2-5. The substrate can be comprised of glass or different metal layers of varying thickness (30 nm to 500 nm). Example metal layers include, but are not limited to, indium tin oxide (ITO), Al, Au, Ag, Cu, Ti, Cr, Mo and combinations of alloys thereof. The substrate can also be comprised of flexible substrate, including formed from Al-mylar, ITO-polyester, ITO-polyethylenenaphthalate and/or ITO-polysulfone. In certain embodiments, the top electrode to complete the device fabrication can include but are not limited to indium tin oxide (ITO), Al, Au, Ag, Cu, Ti, Cr, Mo and combinations of alloys thereof. In one embodiment, the bottom conducting layer is ITO or Al deposited on top of glass and the top electrode is Al.

In another embodiment, the energy storage device is comprised of an ultrathin layer of a polymer having a permittivity of >2 between the substrate with the metal electrode and the sol-gel dielectric layer. The thickness of the polymer layer is typically between 5 to 500 nm. In one embodiment, the ultrathin layer can comprise of an alkylthiol, alkylphosphonic acid, alkyl carboxylic acid or alkylsiloxane. The thickness of the alkylthiol, alkylphosphonic acid, alkyl carboxylic acid or alkylsiloxane layer comprise of 0.2 to 10 nm. In another embodiment, the thickness of the alkylthiol, alkylphosphonic acid, alkyl carboxylic acid or alkylsiloxane layer is >10 nm. The alkylthiol, alkylphosphonic acid, alkyl carboxylic acid or alkylsiloxane in ethanol layer can be coated by dip-, spin-, drop-, blade- or spray coating or by slot die coating.

In another embodiment, the energy storage device is comprised of a thin layer of a polymer having a permittivity of >1 between the sol-gel dielectric layer and the top metal or semiconducting electrode. The thickness of the polymer layer can typically range between 5 to 500 nm. The thin layer can include of an alkylthiol, alkylphosphonic acid, alkyl carboxylic acid or alkylsiloxane. The thickness of the alkylthiol, alkylphosphonic acid, alkyl carboxylic acid or alkylsiloxane layer can range between 0.2 to 10 nm. In another embodiment, the thickness of the alkylthiol, alkylphosphonic acid, alkyl carboxylic acid or alkylsiloxane layer may be less or greater than 10 nm. The alkylthiol, alkyl phosphonic acid or alkylsiloxane in ethanol layer is coated by dip-, spin-, drop-, blade- or spray-coating or slot die coating. In another embodiment, the energy storage device can include a thin layer of a polymer having a permittivity of greater than 1 between the top electrode and the sol-gel dielectric layer and also between the metal or semiconducting bottom electrodes.

In another embodiment, thickness of the polymer layer can range between 5 to 500 nm. The thin layer can comprise of an alkyl thiol, alkyl phosphonic acid or alkyl siloxane. The thickness of the alkylthiol, alkylphosphonic acid, alkyl carboxylic acid or alkylsiloxane layer can comprise of 0.2 to 10 nm. In another embodiment, the thickness of the alkylthiol, alkylphosphonic acid, alkyl carboxylic acid or alkylsiloxane layer can be greater than 10 nm. The alkylthiol, alkylphosphonic acid, alkyl carboxylic acid or alkylsiloxane in ethanol layer is coated by dip-, spin-, drop-, blade- or spray-coating or slot die coating.

Summaries of other example implementations and related data will now be discussed.

### Example 1 (pH 1.5 Sol and Film Fabrication)

A sol-gel composition was prepared by mixing 1 g of 2-cyanoethyltrimethoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 2 (pH 3 Sol and Film Fabrication)

A sol-gel composition was prepared by mixing 1 g of 2-cyanoethyltrimethoxysilane in a vial, 0.5 g methanol followed by 0.5 g of an aqueous hydrochloric acid (pH 3) solution and stirring the resulting mixture for 12 hours at ambient conditions. The reaction mixture yielded a gel after 12 hours of stirring. The solvent/supernatant solution was decanted. The gel was heated to 80° C. for 30 minutes to remove any remaining methanol solvent. The dried gel was dissolved by 30 seconds sonication followed by stirring after addition of 1 mL of solvent such as dimethylformamide or acetone or acetonitrile or dimethylacetamide or propylene carbonate under ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 2000 rpm for 30 seconds. Films were cured at 130° C. for hours under vacuum. Thickness of the films can be varied by using different spin-casting speeds.

### Example 3 (pH 4.8 Sol and Film Fabrication)

A sol-gel composition was prepared by mixing 1 g of 2-cyanoethyltrimethoxysilane in a vial, 0.5 g methanol followed by 0.5 g of an aqueous hydrochloric acid (pH 4.8) solution and stirring the resulting mixture for 12 hours at ambient conditions. The reaction mixture yielded a gel after 12 hours of stirring. The solvent/supernatant solution was decanted. The gel was heated to 80° C. for 30 minutes to remove any remaining methanol solvent. The dried gel was dissolved by 30 seconds sonication followed by stirring after addition of 1 mL of solvent such as dimethylformamide or acetone or acetonitrile or dimethylacetamide or propylene carbonate under ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 2000 rpm for 30 seconds. Films were cured at 130° C. for hours under vacuum. Thickness of the films can be varied by using different spin-casting speeds.

### Example 4 (pH 6.5 Sol and Film Fabrication)

A sol-gel composition was prepared by mixing 1 g of 2-cyanoethyltrimethoxysilane in a vial, 0.5 g methanol followed by 0.5 g of an ultrapure water (pH 6.5) solution and stirring the resulting mixture for 12 hours at ambient conditions. The reaction mixture yielded a gel after 12 hours of stirring. The solvent/supernatant solution was decanted. The gel was heated to 80° C. for 30 minutes to remove any remaining methanol solvent. The dried gel was dissolved by 30 seconds sonication followed by stirring after addition of 1 mL of solvent such as dimethylformamide or acetone or acetonitrile or dimethylacetamide or propylene carbonate under ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 2000 rpm for 30 seconds. Films were cured at 130° C. for hours under vacuum. Thickness of the films can be varied by using different spin-casting speeds.

### Example 5

A sol-gel composition was prepared by mixing 1 g of 3-thiocyanatopropyltriethoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 6

A sol-gel composition was prepared by mixing 1 g of 3-isocyanatopropyltrimethoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 7

A sol-gel composition was prepared by mixing 1 g of 3-aminopropyltrimethoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 8

A sol-gel composition was prepared by mixing 1 g of triethoxysilylbutyraldehyde in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 9

A sol-gel composition was prepared by mixing 1 g of 3-cyanopropyltriemthoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 10

A sol-gel composition was prepared by mixing 1 g of N-(3-Methacryloxy-2-hydroxypropyl)-3-aminopropyltriethoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 11

A mixed sol-gel composition was prepared by mixing 0.5 g of 3-aminopropyltrimethoxysilane along with 0.5 g of 3-isocyanatopropyltrimethoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 12

A mixed sol-gel composition was prepared by mixing 0.5 g of 3-aminopropyltrimethoxysilane along with 0.5 g of 3-cyanoethyltrimethoxysilane in a vial, 0.5 g methanol followed by 0.5 g of 0.1 N hydrochloric acid (pH 1.5) and stirring the resulting mixture for 12 hours at ambient conditions. The sol was filtered using a 0.1 μm prior to spin coating. The sols were spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 5000 rpm for 30 seconds. Films were cured at 130° C. for hours under vacuum. Thickness of the films can be varied by using different spin-casting speeds.

### Example 13

Sol-gel film from Example 1 was immersed into a solution of 0.1 mM of propylphosphonic acid in absolute ethanol at 70° C. for 19 hours. After the treatment, bilayer films were rinsed by ultrasonication in absolute ethanol for ten minutes, blown dry with nitrogen, and stored in a desiccator.

### Example 14

Sol-gel film from Example 1 was immersed into a solution of 0.1 mM of propylphosphonic acid in absolute ethanol at 70° C. for 3 hours. After the treatment, bilayer films were rinsed by ultrasonication in absolute ethanol for ten minutes, blown dry with nitrogen, and stored in a desiccator.

### Example 15

Sol-gel film from Example 1 was immersed into a solution of 0.1 mM of propylphosphonic acid in absolute ethanol at 70° C. for 10 hours. After the treatment, bilayer films were rinsed by ultrasonication in absolute ethanol for ten minutes, blown dry with nitrogen, and stored in a desiccator.

### Example 16

Sol-gel film from Example 1 was immersed into a solution of 0.1 mM of octylphosphonic acid in absolute ethanol at 70° C. for 19 hours. After the treatment, bilayer films were rinsed by ultrasonication in absolute ethanol for ten minutes, blown dry with nitrogen, and stored in a desiccator.

### Example 17

Sol-gel film from Example 1 was immersed into a solution of 0.1 mM of octylphosphonic acid in absolute ethanol at 70° C. for 3 hours. After the treatment, bilayer films were rinsed by ultrasonication in absolute ethanol for ten minutes, blown dry with nitrogen, and stored in a desiccator.

### Example 18

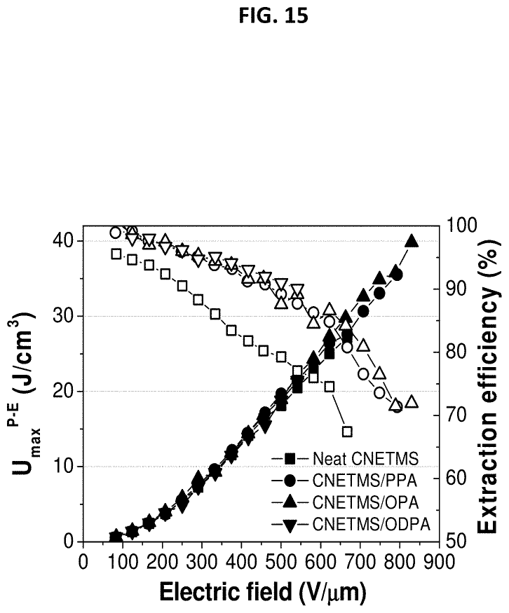

Sol-gel film from Example 1 was immersed into a solution of 0.1 mM of octylphosphonic acid in absolute ethanol at 70° C. for 10 hours. After the treatment, bilayer films were rinsed by ultrasonication in absolute ethanol for ten minutes, blown dry with nitrogen, and stored in a desiccator. The measured energy density and energy extraction efficiency are shown in FIG. 15. More specifically, FIG. 15 depicts the extractable energy density and energy extraction efficiency of CNETMS films with self-assembled monolayer of n-octylphosphonic acid as a charge-blocking layer.

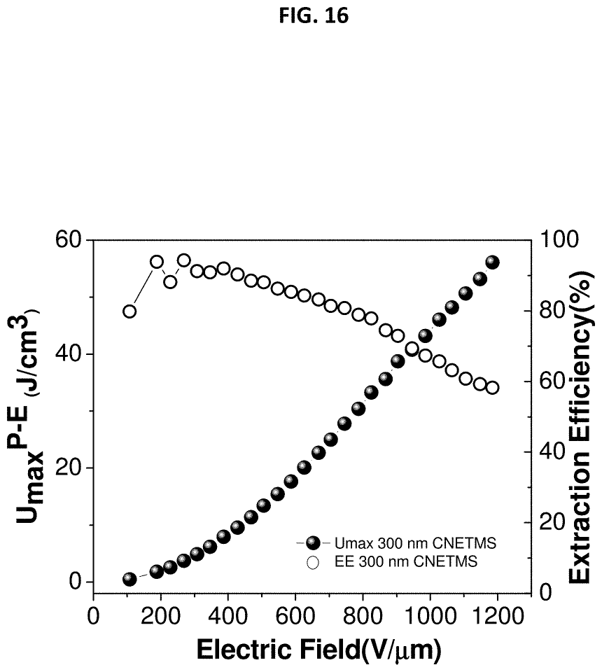

Similarly, FIGS. 16-18 depict extractable energy density and energy extraction efficiency of 85 nm CNETMS films with and without an octylphosphonic acid charge blocking layer. Specifically, FIG. 16 depicts extractable energy density and energy extraction efficiency of 300 nm CNETMS films without a charge-blocking layer. The sol-gel dielectric film shown in FIG. 16 can include a thickness of 300 nm as fabricated. The field dependent Umax of CNETMS processed at a thickness of 300 nm is shown in FIG. 16.

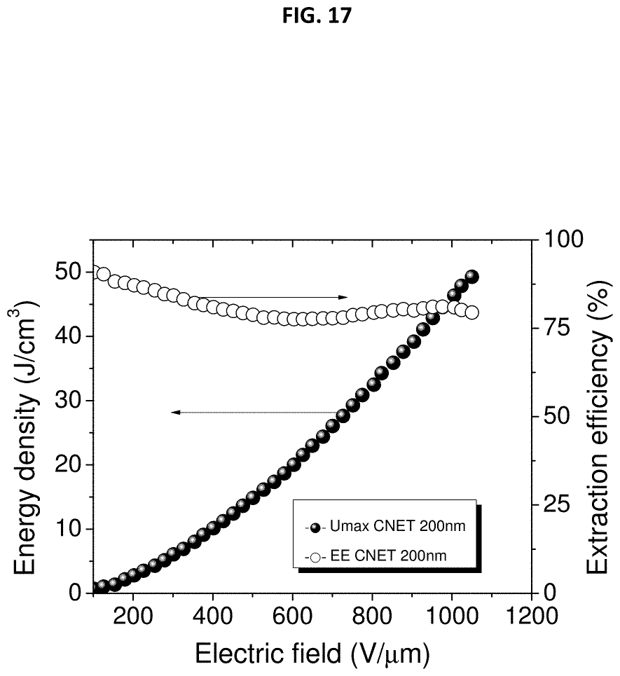

FIG. 17 depicts extractable energy density and energy extraction efficiency of 200 nm CNETMS films with and without self-assembled monolayer of n-octylphosphonic acid as a charge-blocking layer. The sol-gel dielectric film of this example as shown in FIG. 17 can include a thickness of 200 nm as fabricated. The field dependent Umax of CNETMS processed at a thickness of 200 nm is shown in FIG. 17.

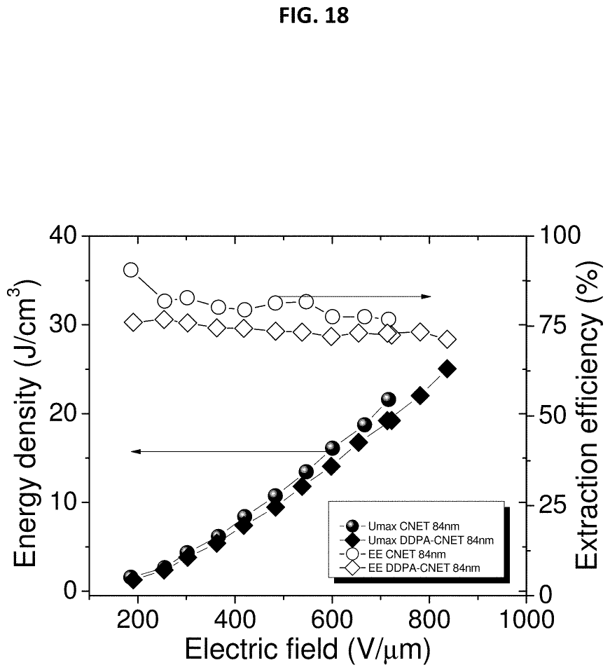

FIG. 18 depicts extractable energy density and energy extraction efficiency of 84 nm CNETMS films with and without self-assembled monolayer of n-octylphosphonic acid as a charge-blocking layer. The sol-gel dielectric film of this example as shown in FIG. 18 can include a thickness of 85 nm as fabricated. The field dependent Umax of CNETMS processed at a thickness of 85 nm is shown in FIG. 18.

### Example 19

Sol-gel film from Example 1 was immersed into a solution of 0.1 mM of octadecylphosphonic acid in absolute ethanol at 70° C. for 19 hours. After the treatment, bilayer films were rinsed by ultrasonication in absolute ethanol for ten minutes, blown dry with nitrogen, and stored in a desiccator.

### Example 20

Sol-gel film from Example 1 was immersed into a solution of 0.1 mM of octadecylphosphonic acid in absolute ethanol at 70° C. for 3 hours. After the treatment, bilayer films were rinsed by ultrasonication in absolute ethanol for ten minutes, blown dry with nitrogen, and stored in a desiccator.

### Example 21

Sol-gel film from Example 1 was immersed into a solution of 0.1 mM of octadecylphosphonic acid in absolute ethanol at 70° C. for 10 hours. After the treatment, bilayer films were rinsed by ultrasonication in absolute ethanol for ten minutes, blown dry with nitrogen, and stored in a desiccator.

### Example 22

A 0.1 mM solution of octylphosphonic acid was spin-coated on top of the sol-gel film from Example 1 at 1000 rpm for 30 seconds. The film was dried at 120° C. for 2 hours in a vacuum oven and stored in a desiccator.

### Example 23

A 0.1 mM solution of octylphosphonic acid was spin-coated on top of the sol-gel film from Example 1 at 6000 rpm for 30 seconds. The film was dried at 120° C. for 2 hours in a vacuum oven and stored in a desiccator.

### Example 24

A 1% solution of polyphenyleneoxide was spin-coated on top of the sol-gel film from Example 1 at 5000 rpm for 30 seconds to obtain a thickness of 20 nm of PPO. The film was dried at 130° C. for 3 hours in a vacuum oven and stored in a desiccator.

### Example 25

A 2% solution of polyphenyleneoxide was spin-coated on top of the sol-gel film from Example 1 at 4000 rpm for 30 seconds to obtain a thickness of 50 nm of PPO. The film was dried at 130° C. for 3 hours in a vacuum oven and stored in a desiccator.

### Example 26

A 2% solution of polyphenyleneoxide was spin-coated on top of the sol-gel film from Example 1 at 1000 rpm for 30 seconds to obtain a thickness of 100 nm of PPO. The film was dried at 130° C. for 3 hours in a vacuum oven and stored in a desiccator.

### Example 27

A 5% solution of polyphenyleneoxide was spin-coated on top of the sol-gel film from Example 1 at 3000 rpm for 30 seconds to obtain a thickness of 350 nm of PPO. The film was dried at 130° C. for 3 hours in a vacuum oven and stored in a desiccator.

### Example 28

A sol-gel composition was prepared by mixing 1 g of 2-cyanoethyltrimethoxysilane in a vial, 0.5 g methanol followed by 0.5 g of an ultrapure water (pH 6.5) solution and stirring the resulting mixture for 12 hours at ambient conditions. The reaction mixture yielded a gel after 12 hours of stirring. The solvent/supernatant solution was decanted. The gel was heated to 80° C. for 30 minutes to remove any remaining methanol solvent. The gel was further dried at 130° C. for 3 hours under vacuum. The dried powder was stored in a desiccator.

### Example 29

1 gram of the dry powder, on the same day the powder was produced, from Example 28 was dissolved in 1 mL of dimethylformamide. The sol was filtered using a 0.1 μm prior to spin coating. The resulting solution was spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 2000 rpm for 30 seconds. Films were cured at 130° C. for 3 hours under vacuum. Thickness of the films can be varied by using different spin-casting speeds. Aluminum electrodes were deposited by e-beam evaporation on top of the films for performing the energy density and extraction efficiencies.

### Example 30

Sol-gel film from Example 29 was immersed into a solution of 0.2 mM of octylphosphonic acid in methanol (not limited to methanol solvent . . . other solvents such as ethanol, tetrahydrofuran and toluene can also be used) for 1 hour. After the treatment, bilayer films were rinsed by ultrasonication in methanol for ten minutes, blown dry with nitrogen, dried at 120° C. for 1 hour on a hot plate and stored in a desiccator.

### Example 31

1 gram of the dry powder (3 weeks after the powder was produced) from Example 28 was dissolved in 1 mL of dimethylformamide. The sol was filtered using a 0.1 μm prior to spin coating. The resulting solution was spin-coated onto various rigid substrates such as indium tin oxide on glass (ITO/glass) and Aluminum/glass as well as flexible substrates Aluminum/Mylar, ITO/polyester and ITO/Polysulfone to make films. Typically, 1 μm thick films were obtained by using a spin-speed of 2000 rpm for 30 seconds. Films were cured at 130° C. for 3 hours under vacuum. Thickness of the films can be varied by using different spin-casting speeds. Aluminum electrodes were deposited by e-beam evaporation on top of the films for performing the energy density and extraction efficiencies.

### Example 32

Sol-gel film from Example 31 was immersed into a solution of 0.2 mM of octylphosphonic acid in methanol for 1 hour. However, this example implementation is not limited, and other solvents can be used such as ethanol, tetrahydrofuran and toluene. After the treatment, bilayer films were rinsed by ultrasonication in methanol for ten minutes, blown dry with nitrogen, dried at 120° C. for 1 hour on a hot plate and stored in a desiccator.

TABLE 1
Dielectric properties of sol-gel films described in examples.

| | Dipole | | | | | Extraction | Pore |
|---|---|---|---|---|---|---|---|
| | moment | e | | Umax^{cp} | Umax^{PE} | Efficiency | size |
| Sol-gel precursor | (D) | (1 kHz) | tans | (Rem’) | (Rem’) | (%) | (nm) |
| 3-Cyanopropyl | 6.1 | 30.7 | 0.04 | 10.7 | 3 | 13 | NA |
| trimethoxysilane | | | | | | | |
| 3-thiocyanatopropyl | 3.4 | 9.5 | 0.11 | 36 | 22.7 | 44 | 1.2 |
| triethoxysilane | | | | | | | |
| 3-isocyanatopropyl | 3.75 | 4.9 | 0.03 | 7.2 | 9 | 34 | 1.5 |
| triethoxysilane | | | | | | | |
| 3-aminopropyl | 3.05 | 12.3 | 0.30 | Leaky | Leaky | Leaky | 0.9 |
| trimethoxysilane | | | | | | | |
| triethoxysilylbutyraldehyde | 1.38 | 6.9 | 0.01 | 2.4 | 2.3 | 70 | |
| N-(3-Methacryloxy-2- | NA | 5.8 | 0.06 | 3.7 | 2 | 63 | NA |
| hydroxypropyl)-3-amino | | | | | | | |
| propyltriethoxysilane | | | | | | | |

TABLE 2
Dielectric properties of energy storage devices
comprising of sol-gel film and a charge-blocking layer.

| Sol-gel precursor | Charge- | | | | | Extraction |
|---|---|---|---|---|---|---|
| (pH used for sol-gel | blocking layer | ε | | Uₘₐₓ^{CD} | Uₘₐₓ^{PE} | Efficiency |
| film fabrication) | (thickness in nm) | (1 kHz) | tanδ | (J/cm³) | (J/cm³) | (%) |
| 2-Cyanoethyl | Top PPO (75 nm) | 17 | 0.017 | 16.5 | 24 | 42 |
| trimethoxysilane | | | | | | |
| (pH 1.5) | | | | | | |
| 2-Cyanoethyl | Bottom PPO (75 nm) | 19 | 0.009 | 15.5 | 22.3 | 75 |
| trimethoxysilane | | | | | | |
| (pH 1.5) | | | | | | |
| 2-Cyanoethyl | Top PPO (75 nm) | 15.6 | 0.006 | 12 | 20.3 | 68 |
| trimethoxysilane | Bottom PPO (75 nm) | | | | | |
| (pH 1.5) | | | | | | |
| 2-Cyanoethyl | Top PPO (75 nm) | 16.1 | 0.009 | 5.5 | 14.6 | 68 |
| trimethoxysilane | Bottom PPO (75 nm) | | | | | |
| (pH 6.5) | | | | | | |
| 2-Cyanoethyl | Top CYTOP (75 nm) | 17.5 | 0.01 | 5.6 | 6.1 | 90 |
| trimethoxysilane | Bottom CYTOP (75 nm) | | | | | |
| (pH 6.5) | | | | | | |
| 2-Cyanoethyl | Top FOx17 (600 nm) | | NA | 11 | 9.4 | 48 |
| trimethoxysilane | Bottom FOx17 (600 nm) | | | | | |
| (pH 6.5) | | | | | | |
| 2-Cyanoethyl | Cytop (20 nm) | 20.2 | NA | 9.5 | 16.5 | NA |
| trimethoxysilane | | | | | | |
| (pH 1.5) | | | | | | |
| 2-Cyanoethyl | Cytop (175 nm) | 11.8 | NA | | 12 | NA |
| trimethoxysilane | | | | | | |
| (pH 1.5) | | | | | | |
| 2-Cyanoethyl | Al₂O₃ (50 nm) | 19.4 | NA | 7.7 | NA | NA |
| trimethoxysilane | | | | | | |
| (pH 1.5) | | | | | | |
| 2-Cyanoethyl | SiO₂ (50 nm) | 19.4 | NA | 4.8 | NA | NA |
| trimethoxysilane | | | | | | |
| (pH 1.5) | | | | | | |
| 2-Cyanoethyl | ZrO₂ (20 nm) | 22.1 | NA | 9.5 | 21 | 38 |
| trimethoxysilane | | | | | | |
| (pH 1.5) | | | | | | |
| 2-Cyanoethyl | ZrO₂ (50 nm) | 22.5 | NA | 13 | 17 | 20 |
| trimethoxysilane | | | | | | |
| (pH 1.5) | | | | | | |
| 2-Cyanoethyl | Propyphosphonic | 20.5 | 0.02 | 27.5 | 35 | 72 |
| trimethoxysilane | acid monolayer | | | | | |
| (pH 1.5) | | | | | | |
| 2-Cyanoethyl | Octylphosphonic | 21.5 | 0.02 | 29 | 40 | 72 |
| trimethoxysilane | acid monolayer | | | | | |
| (pH 1.5) | | | | | | |
| 2-Cyanoethyl | Octadecylphosphonic | 21.2 | 0.02 | 15 | 28 | 89 |
| trimethoxysilane | acid monolayer | | | | | |
| (pH 1.5) | | | | | | |
| 300 nm CNETMS film | None | 21 | 0.025 | 30-35 | 56 | 58 |
| 200 nm CNETMS film | None | 21 | 0.02 | | 49.3 | 79.4 |
| 85 nm CNETMS film | None | 21 | 0.035 | | 25 | 71 |
| 2-cyanoethyl | None | 20.5 | 0.015 | | 30-40 | 80-60 |
| trimethoxysilane | | | | | | |
| polymer powder | | | | | | |
| (as prepared) | | | | | | |
| 2-cyanoethyl | 21 | 0.02 | | | 39-51 | 70 |
| trimethoxysilane | | | | | | |
| polymer powder | | | | | | |
| (3 weeks after the | | | | | | |
| powder was prepared) | | | | | | |

### Electrical Current Measurement

The device structure of certain embodiments, including those tested, can include a substrate such as glass, or polymer having a metal or semiconducting oxide (e.g., transparent or non-transparent such as indium tin oxide or indium zinc oxide) deposited thereon. The sol-gel composition can be spin-coated on top of the metal or semiconducting oxide layer and the sol gel films can be cured at 130° C. for 3 hours prior to the conductivity measurements. Then a second metal layer, such as Aluminum or ITO or gold is formed by sputtering over the sol-gel composition. Electrical leads from a voltage meter can be connected to the sample via a metal layer (e.g., bottom electrode) and metal layer (e.g., top electrode). Electrical measurements can be also carried out on the devices using spring-loaded probes on a probe station.

### Breakdown Strength and Device Reliability

Breakdown strength and device reliability were measured by applying a voltage between the top and bottom electrodes of the sol-gel based device with a ramp of 10 V/s using a Lab View program. Typically, the voltage at which the measured current exceeds 1-5 μA is recorded as the breakdown voltage which is then subjected to the Weibull analysis. The breakdown measurements are performed at least on 20 devices.

### Energy Density by Charge-Discharge (C-D) and Polarization-Electric Field (P-E) Measurements

Energy densities of the devices were measured by using the pulsed charge-discharge method [Kim, P.; Doss, N. M.; Tillotson, J. P.; Hotchkiss, P. J.; Pan, M.-J.; Marder, S. R.; Li, J.; Calame, J. P.; Perry, J. W., ACS Nano 2009, 3 (9), 2581-2592] with a rise time of ˜0.5 ms under various field strengths below the breakdown field. Additionally, polarization-electric field (P-E) measurements were performed with a home-built modified Sawyer-Tower circuit. For P-E measurements, samples were subjected to voltages up to 2 kV, which were supplied by a high voltage amplifier (Trek 610-D, Medina, N.Y.). The induced charge on the sample was measured using a charge integrator circuit. The testing was performed using a unipolar sine waveform with a period of 0.01 seconds. As the sample was tested in air (e.g., not immersed in an insulating liquid), special care was taken to maintain appropriate distances (>1 cm) between probes and cabling to avoid a flash-over.

What is claimed is:

1. A method of forming a device comprising:
reacting a single sol-gel precursor, a solvent, and a catalyst to form a sol-gel film; and
sandwiching the sol-gel film between a first layer and a second layer;
wherein the film has a shelf-life of at least one month.

2. The method of claim 1, wherein reacting comprises:
mixing the single sol-gel precursor with the catalyst to form a mixture;
dissolving the mixture with the solvent to form a solution; and
casting the solution into sol-gel film.

3. The method of claim 2, wherein the single sol-gel precursor has the formula: 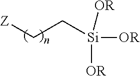
and
wherein:
each R is an alkyl group independently chosen from methyl, ethyl, propyl, and butyl;
Z is a polar group comprising a compound having a dipole moment of at least 0.25 D; and
n is an integer ranging from 0 to 10.

4. The method of claim 3, wherein the catalyst is a liquid catalyst;
wherein reacting further comprises heating or drying the mixture formed by mixing the single sol-gel precursor with the catalyst, forming a powdered mixture; and
wherein dissolving comprises dissolving the powdered mixture with the solvent to form the solution.

5. The method of claim 4, wherein the first layer is selected form the group consisting of:
a polymer layer;
an oxide layer; and
an organic self-assembled monolayer selected from alkyl or aryl thiols, alkyl or aromatic phosphonic acids, alkyl or aryl carboxylic acids or alkyl or aryl silanes, alkyl or aryl siloxanes, or a combination thereof; and
wherein the second layer is selected form the group consisting of:
a polymer layer;
an oxide layer; and
an organic self-assembled monolayer selected from alkyl or aryl thiols, alkyl or aromatic phosphonic acids, alkyl or aryl carboxylic acids or alkyl or aryl silanes, alkyl or aryl siloxanes, or a combination thereof.

6. The method of claim 5, wherein the first and second layers are:
identical polymer layers;
identical oxide layers; or
each an organic self-assembled monolayer selected from alkyl or aryl thiols, alkyl or aromatic phosphonic acids, alkyl or aryl carboxylic acids or alkyl or aryl silanes, alkyl or aryl siloxanes, or a combination thereof.

7. A method of forming a sol-gel thin film device comprising:
reacting a single sol-gel precursor, a solvent, and a catalyst to form a sol-gel film; and
positioning a first charge blocking layer and the sol-gel film between a top electrode and a bottom electrode;
wherein the sol-gel film has a shelf-life of at least one month;
wherein the sol-gel film has an overall weight; and
wherein the single sol-gel precursor has the formula: 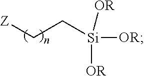
and
wherein:
each R is an alkyl group independently chosen from methyl, ethyl, propyl, and butyl;
Z is a polar group comprising a compound having a dipole moment of at least 0.25 D;
n is an integer ranging from 0 to 10;
the solvent comprises at least 10% of the overall weight; and
the catalyst comprises at least 10% of the overall weight.

8. The method of claim 7, wherein the reacting comprises:
mixing the single sol-gel precursor with the catalyst to form a mixture;
heating or drying the mixture forming a powdered mixture;
dissolving the powdered mixture with the solvent to form a solution; and
casting the solution into the sol-gel film.

9. The method of claim 8 further comprising positioning a second charge blocking layer between the top electrode and the bottom electrode;
wherein casting the solution into the sol-gel film is selected from the group consisting of casting by spin, blade, spray coating, and a combination thereof.

10. The method of claim 9, wherein the first and second charge blocking layers comprise identical polymer layers.

11. The method of claim 9, wherein the first and second charge blocking layers comprise identical oxide layers.

12. The method of claim 9, wherein the first and second charge blocking layers comprise organic self-assembled monolayers, each selected from alkyl or aryl thiols, alkyl or aromatic phosphonic acids, alkyl or aryl carboxylic acids or alkyl or aryl silanes, alkyl or aryl siloxanes,

13. The method of claim 8 further comprising:
selecting the catalyst to hydrolyze and condense the single sol-gel precursor; and
maintaining a relatively high permittivity in the sol-gel film by reducing leakage current of the sol-gel film.

14. The method of claim 7, wherein the sol-gel film has a thickness ranging from 30 nm to 10,000 nm.

15. A method of forming a sol-gel thin film device comprising:
reacting a single sol-gel precursor, a solvent, and a catalyst to form a sol-gel film;
depositing the sol-gel film on a substrate; and
positioning a first charge blocking layer on at least a portion of the top of the film;
wherein the sol-gel film has a shelf-life of at least one month;
wherein the reacting comprises:
mixing the single sol-gel precursor with the catalyst to form a mixture, the catalyst comprising a liquid catalyst;
heating or drying the mixture forming a powdered mixture;
dissolving the powdered mixture with the solvent to form a solution; and
casting the solution the sol-gel film;
wherein the solvent is selected from the group consisting of methanol, ethanol, isopropyl alcohol, N, N-dimethylformamide, acetonitrile, N, N-dimethylacetamide, tetrahydrofuran, an a combination thereof; and
wherein the single sol-gel precursor has the formula: 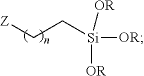
and
wherein:
each R is an alkyl group independently chosen from methyl, ethyl, propyl, and butyl;
Z is a polar group comprising a compound having a dipole moment of at least 0.25 D; and
n is an integer ranging from 0 to 10.

16. The method of claim 15, wherein the first charge-blocking layer has a thickness of from 1 nm to 200 nm and comprises metal oxide; and
wherein the metal oxide comprises a metal selected from the group consisting of Si, Al, Zn, Zr, and Hf.

17. The method of claim 16 further comprising on or more of:
tailoring dielectric permittivity of the powdered mixture; and
tailoring breakdown strength of the powdered mixture.
